(19) United States
(12) Patent Application Publication
(10) Pub. No.: US 2015/0199610 A1
(43) Pub. Date: Jul. 16, 2015

(54) DETERMINING INDOOR LOCATION USING PATTERN MATCHING OF PROXIMAL PEER-TO-PEER DEVICES

(71) Applicant: QUALCOMM Incorporated, San Diego, CA (US)

(72) Inventor: Joshua Dickenson HERSHBERG, Beit Shemesh (IL)

(21) Appl. No.: 14/573,700

(22) Filed: Dec. 17, 2014

Related U.S. Application Data
(60) Provisional application No. 61/926,154, filed on Jan. 10, 2014.

(51) Int. Cl. G06N 5/04; G06N 99/00

(52) U.S. Cl. CPC G06N 5/048; G06N 5/047; G06N 99/005

(57) ABSTRACT

A method, apparatus, and computer-readable storage medium perform Internet of Things (IoT) location categorization using a computing device. The computing device uses discovery processes to determine the types of Internet of Things (IoT) devices in the location. Machine learning, pattern recognition, and/or hard-coding are used to determine the Internet of Things (IoT) location type based on the types of Internet of Things (IoT) devices in the types of Internet of Things (IoT) location. The type of Internet of Things (IoT) location type can be determined to be retail, a home, an office etc.

### CLAIM OF PRIORITY UNDER 35 U.S.C. §119

The present Application for Patent claims priority to Provisional Application No. 61/926,154 entitled DETERMINING INDOOR LOCATION USING PATTERN MATCHING OF PROXIMAL PEER-TO-PEER DEVICES, filed Jan. 10, 2014, by the same inventors as the subject application, assigned to the assignee hereof and hereby expressly incorporated by reference herein in its entirety.

### FIELD

Implementations relate to location determination of Internet of Things (IoT)) devices.

### BACKGROUND

The Internet is a global system of interconnected computers and computer networks that use a standard Internet protocol suite (e.g., the Transmission Control Protocol (TCP) and Internet Protocol (IP)) to communicate with each other. The Internet of Things (IoT)) is based on the idea that everyday objects, not just computers and computer networks, can be readable, recognizable, locatable, addressable, and controllable via an Internet of Things (IoT)) communications network (e.g., an ad-hoc system or the Internet).

As used herein, the term “Internet of Things device” (or “Internet of Things (IoT) device”) may refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An Internet of Things (IoT)) device may have a passive communication interface, such as a quick response (QR) code, a radio-frequency identification (RFID) tag, an NFC tag, or the like, or an active communication interface, such as a modem, a transceiver, a transmitter-receiver, or the like.

An Internet of Things (IoT)) device can have a particular set of attributes and/or properties (e.g., a device state or status, such as whether the Internet of Things (IoT)) device is on or off, open or closed, idle or active, available for task execution or busy, and so on, a cooling or heating function, an environmental monitoring or recording function, a light-emitting function, a sound-emitting function, etc.), which can be embedded in and/or controlled/monitored by a central processing unit (CPU), microprocessor, ASIC, or the like, and configured for connection to an Internet of Things (IoT)) network such as a local ad-hoc network or the Internet. For example, Internet of Things (IoT)) devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the Internet of Things (IoT)) network.

Internet of Things (IoT)) devices may also include cell phones, desktop computers, laptop computers, tablet computers, personal digital assistants (PDAs), etc. Accordingly, the Internet of Things (IoT)) network may be comprised of a combination of “legacy” Internet-accessible devices (e.g., laptop or desktop computers, cell phones, etc.) in addition to devices that do not typically have Internet-connectivity (e.g., dishwashers, etc.).

A number of market trends are driving development of Internet of Things (IoT)) devices. For example, increasing energy costs are driving governments' strategic investments in smart grids and support for future consumption, such as for electric vehicles and public charging stations. Increasing health care costs and aging populations are driving development for remote/connected health care and fitness services. A technological revolution in the home is driving development for new “smart” services, including consolidation by service providers marketing ‘N’ play (e.g., data, voice, video, security, energy management, etc.) and expanding home networks. Buildings are getting smarter and more convenient as a means to reduce operational costs for enterprise facilities.

There are a number of key applications for the Internet of Things (IoT)). For example, in the area of smart grids and energy management, utility companies can optimize delivery of energy to homes and businesses while customers can better manage energy usage. In the area of home and building automation, smart homes and buildings can have centralized control over virtually any device or system in the home or office, from appliances to plug-in electric vehicle (PEV) security systems. In the field of asset tracking, enterprises, hospitals, factories, and other large organizations can accurately track the locations of high-value equipment, patients, vehicles, and so on. In the area of health and wellness, doctors can remotely monitor patients' health while people can track the progress of fitness routines.

As such, in the near future, increasing development in Internet of Things (IoT)) technologies will lead to numerous Internet of Things (IoT)) devices surrounding a user at home, in vehicles, at work, and many other locations. However, despite the fact that Internet of Things (IoT)) capable devices can provide substantial real-time information about the environment surrounding a user (e.g., likes, choices, habits, device conditions, etc.), it can be relatively difficult to categorize a particular place where computing devices, such as laptops computers, smart phones, tablets, or the like, that communicate with Internet of Things (IoT)) device are located.

### SUMMARY

An example implementation of the technology described herein is directed to a method of determining a location type for a computing device. The method includes acquiring a presence of a set of Internet of Things (IoT) devices, determining classifications of device types of the one or more IoT devices, and determining a location type for the computing device based at least in part on the classifications of device types.

Another example implementation is directed to an apparatus for determining a location type for a computing device. The apparatus includes logic that is configured to acquire a presence of a set of Internet of Things (IoT) devices, logic that is configured to determine classifications of device types of the one or more IoT devices, and logic that is configured to determine a location type for the computing device based at least in part on the classifications of device types.

Another example implementation is directed to an apparatus for determining a location type for a computing device. The apparatus includes means for acquiring a presence of a set of Internet of Things (IoT) devices, means for determining classifications of device types of the one or more IoT devices, and means for determining a location type for the computing device based at least in part on the classifications of device types.

Another example implementation is directed to a computer-readable storage medium including data that, when accessed by a machine, cause the machine to perform operations for determining a location type for a computing device. The operations include acquiring a presence of a set of Internet of Things (IoT) devices, determining classifications of device types of the one or more IoT devices, and determining a location type for the computing device based at least in part on the classifications of device types.

Above is a simplified Summary relating to one or more implementations described herein. As such, the Summary should not be considered an extensive overview relating to all contemplated aspects and/or implementations, nor should the Summary be regarded to identify key or critical elements relating to all contemplated aspects and/or implementations or to delineate the scope associated with any particular aspect and/or implementation. Accordingly, the Summary has the sole purpose of presenting certain concepts relating to one or more aspects and/or implementations relating to the mechanisms disclosed herein in a simplified form to precede the detailed description presented below.

### BRIEF DESCRIPTION OF THE DRAWINGS

The accompanying drawings are presented to aid in the description of the technology described herein and are provided solely for illustration of the implementations and not for limitation of the implementations.

FIG. 1A illustrates a high-level system architecture of a wireless communications system in accordance with one or more implementations of the technology described herein.

FIG. 1B illustrates a high-level system architecture of a wireless communications system in accordance with one or more implementations of the technology described herein.

FIG. 1C illustrates a high-level system architecture of a wireless communications system in accordance with one or more implementations of the technology described herein.

FIG. 1D illustrates a high-level system architecture of a wireless communications system in accordance with one or more implementations of the technology described herein.

FIG. 1E illustrates a high-level system architecture of a wireless communications system in accordance with one or more implementations of the technology described herein.

FIG. 2A illustrates an example Internet of Things (IoT)) device in accordance with aspects of the disclosure, while FIG. 2B illustrates an example passive Internet of Things (IoT)) device in accordance with one or more implementations of the technology described herein.

FIG. 3 illustrates a communication device that includes logic configured to perform functionality in accordance with one or more implementations of the technology described herein.

FIG. 4 illustrates an example server in accordance with one or more implementations of the technology described herein.

FIG. 5 illustrates an example of an Internet of Things (IoT)) environment in accordance with one or more implementations of the technology described herein.

FIG. 6 illustrates an example of an Internet of Things (IoT)) home environment in accordance with one or more implementations of the technology described herein.

FIG. 7 illustrates an example of an Internet of Things (IoT)) office in accordance with one or more implementations of the technology described herein.

FIG. 8 illustrates an example of an Internet of Things (IoT)) retail environment in accordance with one or more implementations of the technology described herein.

FIG. 9 illustrates an example message sequence in which a type of Internet of Things (IoT)) environment is recognized in accordance with one or more implementations of the technology described herein.

### DETAILED DESCRIPTION

As described above, conventionally it can be relatively difficult to categorize the type of Internet of Things (IoT)) environment where a computing device such as a smart phone is located. That is, it can be difficult to know whether the computing device is located in a residential home, an office environment, a retail store, vehicles, stadiums, etc. One or more implementations of the technology described determines an indoor location type using pattern matching of a set of proximal peer-to-peer Internet of Things (IoT)) devices.

In one implementation, a computing device acquires announcements from Internet of Things (IoT) devices and classifies the Internet of Things (IoT) device types using the announcements. The computing device observes patterns for the Internet of Things (IoT) devices, their quantities, transience, etc. A pattern recognition module uses the patterns for the Internet of Things (IoT) devices, their quantities, transience, etc., to determine the location type for the computing device. The pattern recognition module may make heuristic and probabilistic determinations using machine learning implemented in a machine learning module, and/or hard-coded logic to categorize/classify the Internet of Things (IoT) location type with a confidence level. The pattern recognition module then returns the category and confidence level to the computing device.

As an example, suppose that one Internet of Things (IoT) environment includes three handsets, a television, refrigerator, coffee maker, oven, a fax machine, washing machine, and a dryer. Suppose further that their Internet of Things (IoT) device type announcements do not change and they are not transient. Suppose further that a second Internet of Things (IoT) environment includes several handsets, a printer, a refrigerator, a commercial espresso machine, a fax machine, a commercial coffee bean grinding machine, and a commercial dishwasher. The Internet of Things (IoT) device type announcements change often for the handsets, because the handsets are transient, but not for the other Internet of Things (IoT) devices in the Internet of Things (IoT) environment. Given this scenario, the pattern recognition module uses the patterns for the Internet of Things (IoT) devices, their quantities, transience, etc., and determines that the location type for the computing device in the first Internet of Things (IoT) environment is a home and that the location type for the computing device in the second Internet of Things (IoT) environment is a coffee shop. Even though both environments include a refrigerator and a fax machine, the transience of Internet of Things (IoT) device types, among other things, in the particular environment enables the pattern recognition module to categorize/classify the Internet of Things (IoT) location type.

Moreover, suppose that there are five Internet of Things (IoT) locations that already have been categorized, based on machine learning, pattern recognition, and/or hard coding, for example. The pattern recognition module may look at the characteristics of each of the Internet of Things (IoT) devices in the five locations based on their announcements. The pattern recognition module may determine the likelihood of those Internet of Things (IoT) devices being present in those kinds of locations. Thus, if there are one hundred locations that are categorized as a coffee shop, and each of the one hundred locations has Internet of Things (IoT)-enabled commercial espresso machines, then the next time the computing device enters a location that the pattern recognition module has not yet categorized, and the computing device detects a commercial espresso machine, the pattern recognition module will determine that the location type that the computing device entered is likely a coffee shop.

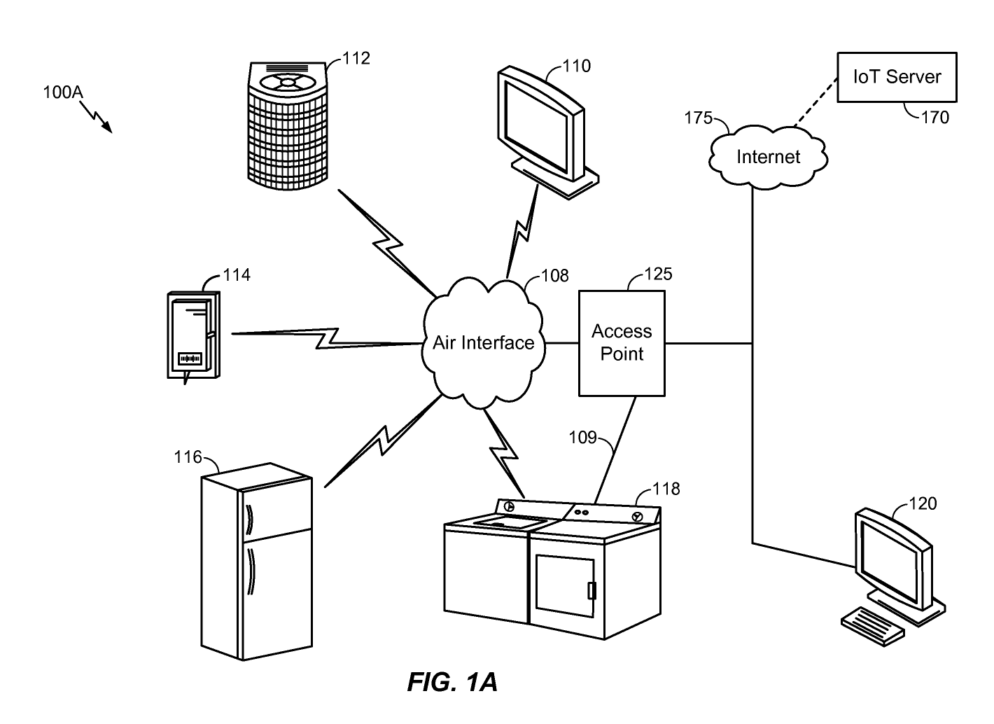

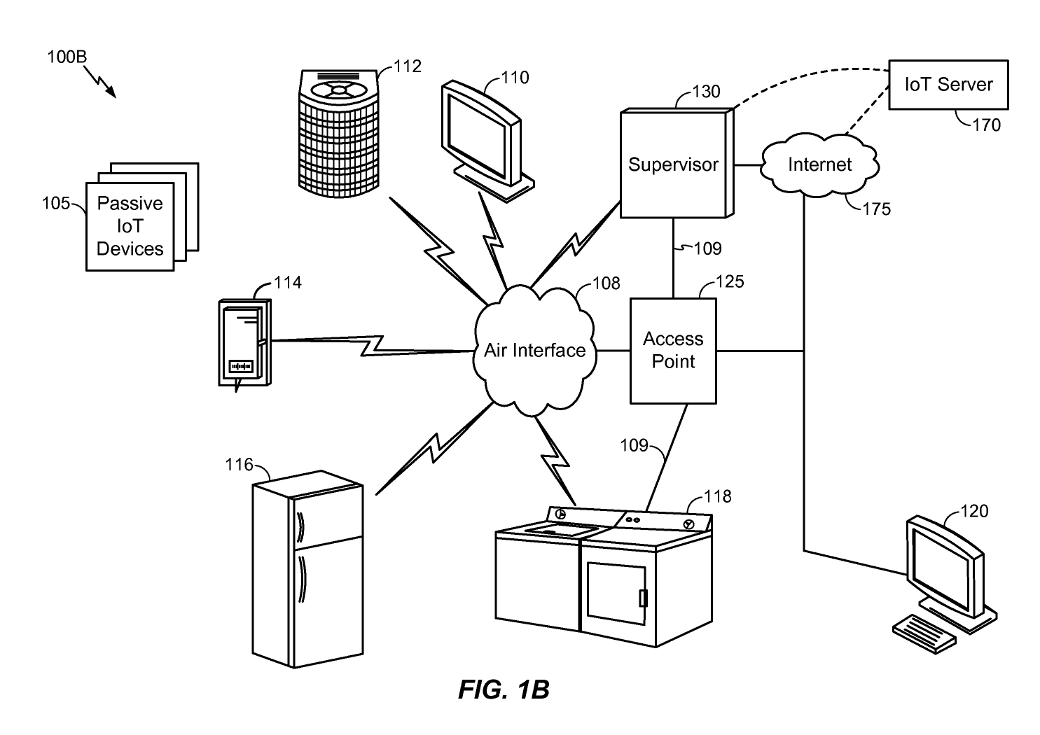

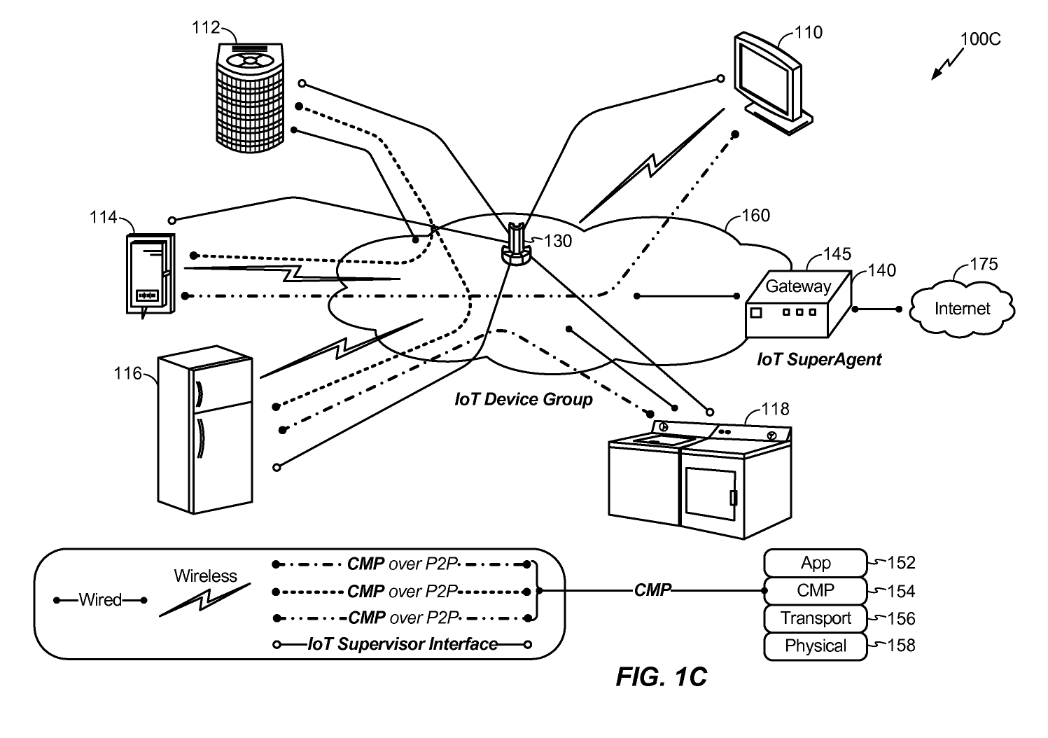

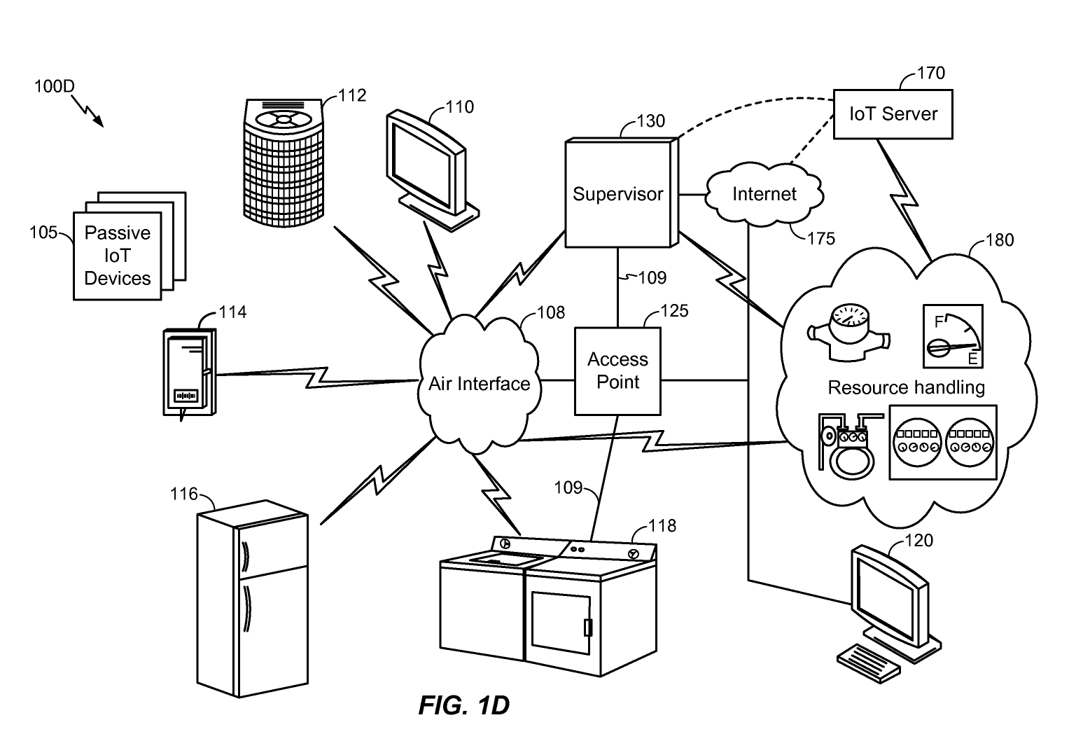

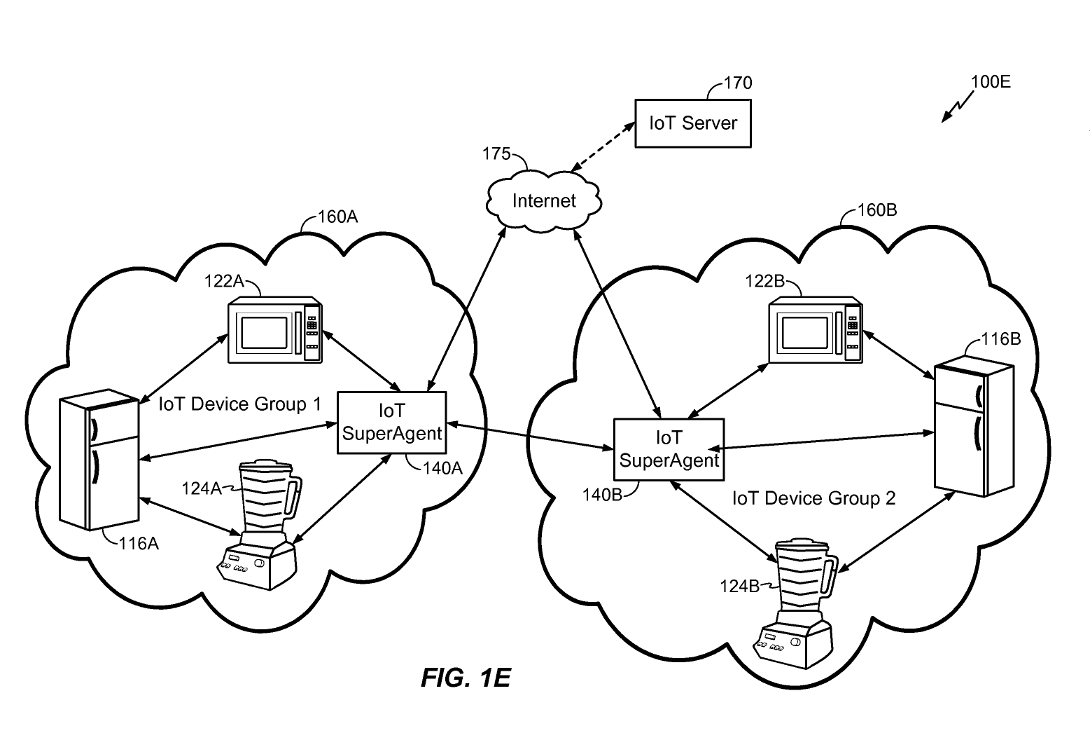

FIG. 1A illustrates a high-level system architecture of a wireless communications system 100A in accordance with an implementation of the technology described herein. The wireless communications system 100A contains a plurality of Internet of Things (IoT)) devices, which include a television 110, an outdoor air conditioning unit 112, a thermostat 114, a refrigerator 116, and a washer and dryer 118.

Referring to FIG. 1A, Internet of Things (IoT)) devices 110-118 are configured to communicate with an access network (e.g., an access point 125) over a physical communications interface or layer, shown in FIG. 1A as air interface 108 and a direct wired connection 109. The air interface 108 can comply with a wireless Internet protocol (IP), such as IEEE 802.11. Although FIG. 1A illustrates Internet of Things (IoT)) devices 110-118 communicating over the air interface 108 and Internet of Things (IoT)) device 118 communicating over the wired connection 109, each Internet of Things (IoT)) device may communicate over a wired or wireless connection, or both.

The Internet 175 includes a number of routing agents and processing agents (not shown in FIG. 1A for the sake of convenience). The Internet 175 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed, and received at the destination.

In FIG. 1A, a computer 120, such as a desktop or personal computer (PC), is shown as connecting to the Internet 175 directly (e.g., over an Ethernet connection or Wi-Fi or 802.11-based network). The computer 120 may have a wired connection to the Internet 175, such as a direct connection to a modem or router, which, in an example, can correspond to the access point 125 itself (e.g., for a Wi-Fi router with both wired and wireless connectivity). Alternatively, rather than being connected to the access point 125 and the Internet 175 over a wired connection, the computer 120 may be connected to the access point 125 over air interface 108 or another wireless interface, and access the Internet 175 over the air interface. Although illustrated as a desktop computer, computer 120 may be a laptop computer, a tablet computer, a PDA, a smart phone, or the like. The computer 120 may be an Internet of Things (IoT)) device and/or contain functionality to manage an Internet of Things (IoT)) network/group, such as the network/group of Internet of Things (IoT)) devices 110-118.

The access point 125 may be connected to the Internet 175 via, for example, an optical communication system, such as FiOS, a cable modem, a digital subscriber line (DSL) modem, or the like. The access point 125 may communicate with Internet of Things (IoT)) devices 110-120 and the Internet 175 using the standard Internet protocols (e.g., TCP/IP).

Referring to FIG. 1A, an Internet of Things (IoT)) server 170 is shown as connected to the Internet 175. The Internet of Things (IoT)) server 170 can be implemented as a plurality of structurally separate servers, or alternatively may correspond to a single server. In an implementation of the technology described herein, the Internet of Things (IoT)) server 170 is optional (as indicated by the dotted line), and the group of Internet of Things (IoT)) devices 110-120 may be a peer-to-peer (P2P) network. In such a case, the Internet of Things (IoT)) devices 110-120 can communicate with each other directly over the air interface 108 and/or the wired connection 109. Alternatively, or additionally, some or all of Internet of Things (IoT)) devices 110-120 may be configured with a communication interface independent of air interface 108 and wired connection 109. For example, if the air interface 108 corresponds to a Wi-Fi interface, certain of the Internet of Things (IoT)) devices 110-120 may have Bluetooth or NFC interfaces for communicating directly with each other or other Bluetooth or NFC-enabled devices.

In a peer-to-peer network, service discovery schemes can multicast the presence of nodes, their capabilities, and group membership. The peer-to-peer devices can establish associations and subsequent interactions based on this information.

In accordance with an implementation of the technology described herein, FIG. 1B illustrates a high-level architecture of another wireless communications system 100B that contains a plurality of Internet of Things (IoT)) devices. In general, the wireless communications system 100B shown in FIG. 1B may include various components that are the same and/or substantially similar to the wireless communications system 100A shown in FIG. 1A, which was described in greater detail above (e.g., various Internet of Things (IoT)) devices, including a television 110, outdoor air conditioning unit 112, thermostat 114, refrigerator 116, and washer and dryer 118, that are configured to communicate with an access point 125 over an air interface 108 and/or a direct wired connection 109, a computer 120 that directly connects to the Internet 175 and/or connects to the Internet 175 through access point 125, and an Internet of Things (IoT)) server 170 accessible via the Internet 175, etc.). As such, for brevity and ease of description, various details relating to certain components in the wireless communications system 100B shown in FIG. 1B may be omitted herein to the extent that the same or similar details have already been provided above in relation to the wireless communications system 100A illustrated in FIG. 1A.

Referring to FIG. 1B, the wireless communications system 100B may include a supervisor device 130, which may alternatively be referred to as an Internet of Things (IoT)) manager 130 or Internet of Things (IoT)) manager device 130. As such, where the following description uses the term “supervisor device” 130, those skilled in the art will appreciate that any references to an Internet of Things (IoT)) manager, group owner, or similar terminology may refer to the supervisor device 130 or another physical or logical component that provides the same or substantially similar functionality.

In one implementation, the supervisor device 130 may generally observe, monitor, control, or otherwise manage the various other components in the wireless communications system 100B. For example, the supervisor device 130 can communicate with an access network (e.g., access point 125) over air interface 108 and/or a direct wired connection 109 to monitor or manage attributes, activities, or other states associated with the various Internet of Things (IoT)) devices 110-120 in the wireless communications system 100B. The supervisor device 130 may have a wired or wireless connection to the Internet 175 and optionally to the Internet of Things (IoT)) server 170 (shown as a dotted line). The supervisor device 130 may acquire information from the Internet 175 and/or the Internet of Things (IoT)) server 170 that can be used to further monitor or manage attributes, activities, or other states associated with the various Internet of Things (IoT) devices 110-120.

The supervisor device 130 may be a standalone device or one of Internet of Things (IoT) devices 110-120, such as computer 120. The supervisor device 130 may be a physical device or a software application running on a physical device. The supervisor device 130 may include a user interface that can output information relating to the monitored attributes, activities, or other states associated with the Internet of Things (IoT) devices 110-120 and receive input information to control or otherwise manage the attributes, activities, or other states associated therewith. Accordingly, the supervisor device 130 may generally include various components and support various wired and wireless communication interfaces to observe, monitor, control, or otherwise manage the various components in the wireless communications system 100B.

The wireless communications system 100B shown in FIG. 1B may include one or more passive Internet of Things (IoT) devices 105 (in contrast to the active Internet of Things (IoT) devices 110-120) that can be coupled to or otherwise made part of the wireless communications system 100B. In general, the passive Internet of Things (IoT) devices 105 may include barcoded devices, Bluetooth devices, radio frequency (RF) devices, RFID tagged devices, infrared (IR) devices, NFC tagged devices, or any other suitable device that can provide its identifier and attributes to another device when queried over a short range interface. Active Internet of Things (IoT) devices may detect, store, communicate, act on, and/or the like, changes in attributes of passive Internet of Things (IoT) devices.

For example, passive Internet of Things (IoT) devices 105 may include a coffee cup and a container of orange juice that each has an RFID tag or barcode. A cabinet Internet of Things (IoT) device and the refrigerator Internet of Things (IoT) device 116 may each have an appropriate scanner or reader that can read the RFID tag or barcode to detect when the coffee cup and/or the container of orange juice passive Internet of Things (IoT) devices 105 have been added or removed. In response to the cabinet Internet of Things (IoT) device detecting the removal of the coffee cup passive Internet of Things (IoT) device 105 and the refrigerator Internet of Things (IoT) device 116 detecting the removal of the container of orange juice passive Internet of Things (IoT) device, the supervisor device 130 may receive one or more signals that relate to the activities detected at the cabinet Internet of Things (IoT) device and the refrigerator Internet of Things (IoT) device 116. The supervisor device 130 may then infer that a user is drinking orange juice from the coffee cup and/or likes to drink orange juice from a coffee cup.

Although the foregoing describes the passive Internet of Things (IoT) devices 105 as having some form of RF or barcode communication interfaces, the passive Internet of Things (IoT) devices 105 may include one or more devices or other physical objects that do not have such communication capabilities. For example, certain Internet of Things (IoT) devices may have appropriate scanner or reader mechanisms that can detect shapes, sizes, colors, and/or other observable features associated with the passive Internet of Things (IoT) devices 105 to identify the passive Internet of Things (IoT) devices 105. In this manner, any suitable physical object may communicate its identity and attributes and become part of the wireless communication system 100B and be observed, monitored, controlled, or otherwise managed with the supervisor device 130. Further, passive Internet of Things (IoT) devices 105 may be coupled to or otherwise made part of the wireless communications system 100A in FIG. 1A and observed, monitored, controlled, or otherwise managed in a substantially similar manner.

In accordance with another implementation of the technology described herein, FIG. 1C illustrates a high-level architecture of another wireless communications system 100C that contains a plurality of Internet of Things (IoT) devices. In general, the wireless communications system 100C shown in FIG. 1C may include various components that are the same and/or substantially similar to the wireless communications systems 100A and 100B shown in FIGS. 1A and 1B, respectively, which were described in greater detail above. As such, for brevity and ease of description, various details relating to certain components in the wireless communications system 100C shown in FIG. 1C may be omitted herein to the extent that the same or similar details have already been provided above in relation to the wireless communications systems 100A and 100B illustrated in FIGS. 1A and 1B, respectively.

The communications system 100C shown in FIG. 1C illustrates example peer-to-peer communications between the Internet of Things (IoT) devices 110-118 and the supervisor device 130. As shown in FIG. 1C, the supervisor device 130 communicates with each of the Internet of Things (IoT) devices 110-118 over an Internet of Things (IoT) supervisor interface. Further, Internet of Things (IoT) devices 110 and 114, Internet of Things (IoT) devices 112, 114, and 116, and Internet of Things (IoT) devices 116 and 118, communicate directly with each other.

The Internet of Things (IoT) devices 110-118 make up an Internet of Things (IoT) group 160. An Internet of Things (IoT) device group 160 is a group of locally connected Internet of Things (IoT) devices, such as the Internet of Things (IoT) devices connected to a user's home network. Although not shown, multiple Internet of Things (IoT) device groups may be connected to and/or communicate with each other via an Internet of Things (IoT) SuperAgent 140 connected to the Internet 175. At a high level, the supervisor device 130 manages intra-group communications, while the Internet of Things (IoT) SuperAgent 140 can manage inter-group communications. Although shown as separate devices, the supervisor device 130 and the Internet of Things (IoT) SuperAgent 140 may be, or reside on, the same device (e.g., a standalone device or an Internet of Things (IoT) device, such as computer 120 in FIG. 1A). Alternatively, the Internet of Things (IoT) SuperAgent 140 may correspond to or include the functionality of the access point 125. As yet another alternative, the Internet of Things (IoT) SuperAgent 140 may correspond to or include the functionality of an Internet of Things (IoT) server, such as Internet of Things (IoT) server 170. The Internet of Things (IoT) SuperAgent 140 may encapsulate gateway functionality 145.

Each Internet of Things (IoT) device 110-118 can treat the supervisor device 130 as a peer and transmit attribute/schema updates to the supervisor device 130. When an Internet of Things (IoT) device needs to communicate with another Internet of Things (IoT) device, it can request the pointer to that Internet of Things (IoT) device from the supervisor device 130 and then communicate with the target Internet of Things (IoT) device as a peer. The Internet of Things (IoT) devices 110-118 communicate with each other over a peer-to-peer communication network using a common messaging protocol (CMP). As long as two Internet of Things (IoT) devices are CMP-enabled and connected over a common communication transport, they can communicate with each other. In the protocol stack, the CMP layer 154 is below the application layer 152 and above the transport layer 156 and the physical layer 158.

In accordance with another implementation of the technology described herein, FIG. 1D illustrates a high-level architecture of another wireless communications system 100D that contains a plurality of Internet of Things (IoT) devices. In general, the wireless communications system 100D shown in FIG. 1D may include various components that are the same and/or substantially similar to the wireless communications systems 100A-C shown in FIGS. 1-C, respectively, which were described in greater detail above. As such, for brevity and ease of description, various details relating to certain components in the wireless communications system 100D shown in FIG. 1D may be omitted herein to the extent that the same or similar details have already been provided above in relation to the wireless communications systems 100A-C illustrated in FIGS. 1A-C, respectively.

The Internet 175 is a “resource” that can be regulated using the concept of the Internet of Things (IoT). However, the Internet 175 is just one example of a resource that is regulated, and any resource could be regulated using the concept of the Internet of Things (IoT). Other resources that can be regulated include, but are not limited to, electricity, gas, storage, security, and the like. An Internet of Things (IoT) device may be connected to the resource and thereby regulate it, or the resource could be regulated over the Internet 175. FIG. 1D illustrates several resources 180, such as natural gas, gasoline, hot water, and electricity, wherein the resources 180 can be regulated in addition to and/or over the Internet 175.

Internet of Things (IoT) devices can communicate with each other to regulate their use of a resource 180. For example, Internet of Things (IoT) devices such as a toaster, a computer, and a hairdryer may communicate with each other over a Bluetooth communication interface to regulate their use of electricity (the resource 180). As another example, Internet of Things (IoT) devices such as a desktop computer, a telephone, and a tablet computer may communicate over a Wi-Fi communication interface to regulate their access to the Internet 175 (the resource 180). As yet another example, Internet of Things (IoT) devices such as a stove, a clothes dryer, and a water heater may communicate over a Wi-Fi communication interface to regulate their use of gas. Alternatively, or additionally, each Internet of Things (IoT) device may be connected to an Internet of Things (IoT) server, such as Internet of Things (IoT) server 170, which has logic to regulate their use of the resource 180 based on information received from the Internet of Things (IoT) devices.

In accordance with another implementation of the technology described herein, FIG. 1E illustrates a high-level architecture of another wireless communications system 100E that contains a plurality of Internet of Things (IoT) devices. In general, the wireless communications system 100E shown in FIG. 1E may include various components that are the same and/or substantially similar to the wireless communications systems 100A-D shown in FIGS. 1-D, respectively, which were described in greater detail above. As such, for brevity and ease of description, various details relating to certain components in the wireless communications system 100E shown in FIG. 1E may be omitted herein to the extent that the same or similar details have already been provided above in relation to the wireless communications systems 100A-D illustrated in FIGS. 1A-D, respectively.

The communications system 100E includes two Internet of Things (IoT) device groups 160A and 160B. Multiple Internet of Things (IoT) device groups may be connected to and/or communicate with each other via an Internet of Things (IoT) SuperAgent connected to the Internet 175. At a high level, an Internet of Things (IoT) SuperAgent may manage inter-group communications among Internet of Things (IoT) device groups. For example, in FIG. 1E, the Internet of Things (IoT) device group 160A includes Internet of Things (IoT) devices 116A, 122A, and 124A and an Internet of Things (IoT) SuperAgent 140A, while Internet of Things (IoT) device group 160B includes Internet of Things (IoT) devices 116B, 122B, and 124B and an Internet of Things (IoT) SuperAgent 140B. As such, the Internet of Things (IoT) SuperAgents 140A and 140B may connect to the Internet 175 and communicate with each other over the Internet 175 and/or communicate with each other directly to facilitate communication between the Internet of Things (IoT) device groups 160A and 160B. Furthermore, although FIG. 1E illustrates two Internet of Things (IoT) device groups 160A and 160B communicating with each other via Internet of Things (IoT) SuperAgents 160A and 160B, those skilled in the art will appreciate that any number of Internet of Things (IoT) device groups may suitably communicate with each other using Internet of Things (IoT) SuperAgents.

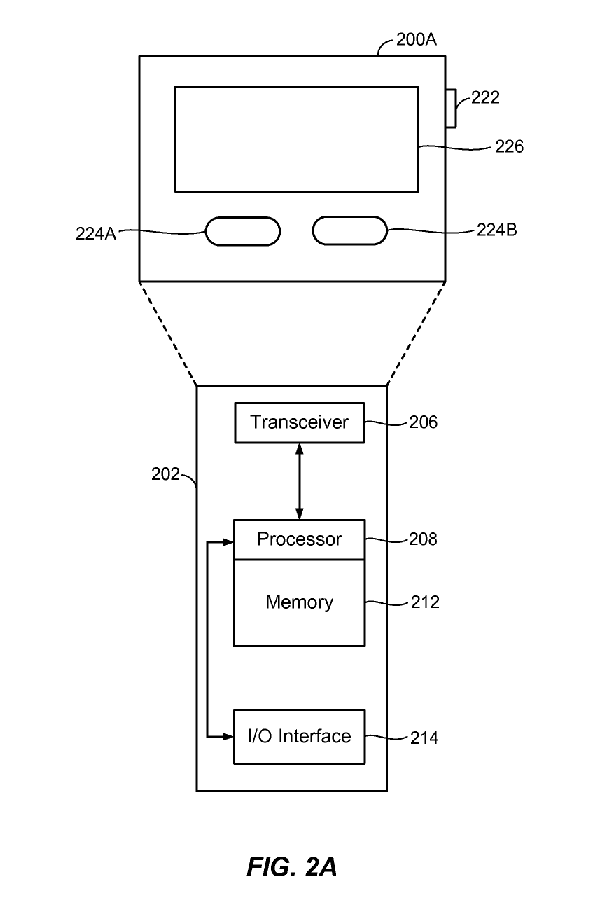

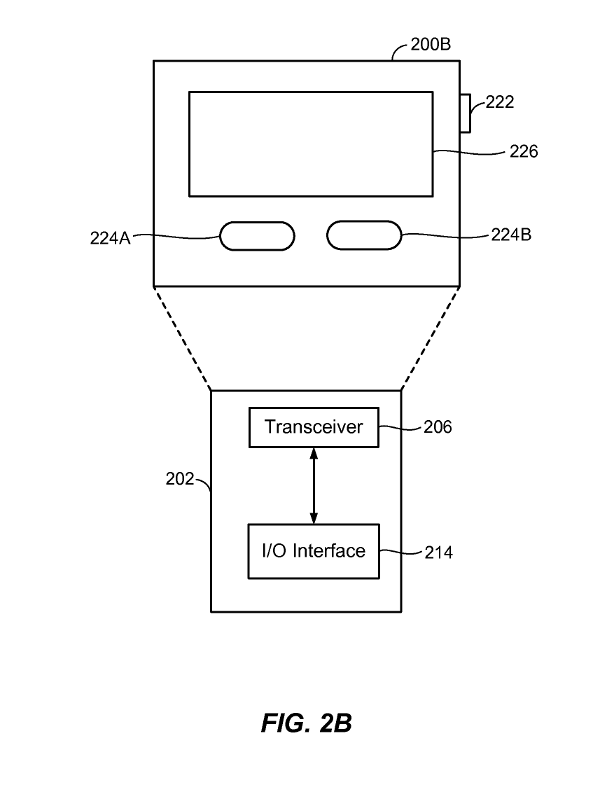

FIG. 2A illustrates a high-level example of an Internet of Things (IoT) device 200A in accordance with aspects of the disclosure. While external appearances and/or internal components can differ significantly among Internet of Things (IoT) devices, most Internet of Things (IoT) devices will have some sort of user interface, which may comprise a display and a means for user input. Internet of Things (IoT) devices without a user interface can be communicated with remotely over a wired or wireless network, such as air interface 108 in FIGS. 1A-B.

As shown in FIG. 2A, in an example configuration for the Internet of Things (IoT) device 200A, an external casing of Internet of Things (IoT) device 200A may be configured with a display 226, a power button 222, and two control buttons 224A and 224B, among other components, as is known in the art. The display 226 may be a touchscreen display, in which case the control buttons 224A and 224B may not be necessary. While not shown explicitly as part of Internet of Things (IoT) device 200A, the Internet of Things (IoT) device 200A may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

While internal components of Internet of Things (IoT) devices, such as Internet of Things (IoT) device 200A, can be embodied with different hardware configurations, a basic high-level configuration for internal hardware components is shown as platform 202 in FIG. 2A. The platform 202 can receive and execute software applications, data, and/or commands transmitted over a network interface, such as air interface 108 in FIGS. 1A-B and/or a wired interface. The platform 202 can also independently execute locally stored applications. The platform 202 can include one or more transceivers 206 configured for wired and/or wireless communication (e.g., a Wi-Fi transceiver, a Bluetooth transceiver, a cellular transceiver, a satellite transceiver, a GPS or SPS receiver, etc.) operably coupled to one or more processors 208, such as a microcontroller, microprocessor, application specific integrated circuit, digital signal processor (DSP), programmable logic circuit, or other data processing device, which will be generally referred to as processor 208. The processor 208 can execute application programming instructions within a memory 212 of the Internet of Things (IoT) device. The memory 212 can include one or more of read-only memory (ROM), random-access memory (RAM), electrically erasable programmable ROM (EEPROM), flash cards, or any memory common to computer platforms. One or more input/output (I/O) interfaces 214 can be configured to allow the processor 208 to communicate with and control from various I/O devices such as the display 226, power button 222, control buttons 224A and 224B as illustrated, and any other devices, such as sensors, actuators, relays, valves, switches, and the like associated with the Internet of Things (IoT) device 200A.

Accordingly, an implementation of the technology described herein can include an Internet of Things (IoT) device (e.g., Internet of Things (IoT) device 200A) including the ability to perform the functions described herein. As will be appreciated by those skilled in the art, the various logic elements can be embodied in discrete elements, software modules executed on a processor (e.g., processor 208) or any combination of software and hardware to achieve the functionality disclosed herein. For example, transceiver 206, processor 208, memory 212, and I/O interface 214 may all be used cooperatively to load, store and execute the various functions disclosed herein and thus the logic to perform these functions may be distributed over various elements. Alternatively, the functionality could be incorporated into one discrete component. Therefore, the features of the Internet of Things (IoT) device 200A in FIG. 2A are to be considered merely illustrative and the disclosure is not limited to the illustrated features or arrangement.

FIG. 2B illustrates a high-level example of a passive Internet of Things (IoT) device 200B in accordance with aspects of the disclosure. In general, the passive Internet of Things (IoT) device 200B shown in FIG. 2B may include various components that are the same and/or substantially similar to the Internet of Things (IoT) device 200A shown in FIG. 2A, which was described in greater detail above. As such, for brevity and ease of description, various details relating to certain components in the passive Internet of Things (IoT) device 200B shown in FIG. 2B may be omitted herein to the extent that the same or similar details have already been provided above in relation to the Internet of Things (IoT) device 200A illustrated in FIG. 2A.

The passive Internet of Things (IoT) device 200B shown in FIG. 2B may generally differ from the Internet of Things (IoT) device 200A shown in FIG. 2A in that the passive Internet of Things (IoT) device 200B may not have a processor, internal memory, or certain other components. Instead, in one implementation, the passive Internet of Things (IoT) device 200A may only include an I/O interface 214 or other suitable mechanism that allows the passive Internet of Things (IoT) device 200B to be observed, monitored, controlled, managed, or otherwise known within a controlled Internet of Things (IoT) network. For example, in one implementation, the I/O interface 214 associated with the passive Internet of Things (IoT) device 200B may include a barcode, Bluetooth interface, radio frequency (RF) interface, RFID tag, IR interface, NFC interface, or any other suitable I/O interface that can provide an identifier and attributes associated with the passive Internet of Things (IoT) device 200B to another device when queried over a short range interface (e.g., an active Internet of Things (IoT) device, such as Internet of Things (IoT) device 200A, that can detect, store, communicate, act on, or otherwise process information relating to the attributes associated with the passive Internet of Things (IoT) device 200B).

Although the foregoing describes the passive Internet of Things (IoT) device 200B as having some form of RF, barcode, or other I/O interface 214, the passive Internet of Things (IoT) device 200B may comprise a device or other physical object that does not have such an I/O interface 214. For example, certain Internet of Things (IoT) devices may have appropriate scanner or reader mechanisms that can detect shapes, sizes, colors, and/or other observable features associated with the passive Internet of Things (IoT) device 200B to identify the passive Internet of Things (IoT) device 200B. In this manner, any suitable physical object may communicate its identity and attributes and be observed, monitored, controlled, or otherwise managed within a controlled Internet of Things (IoT) network.

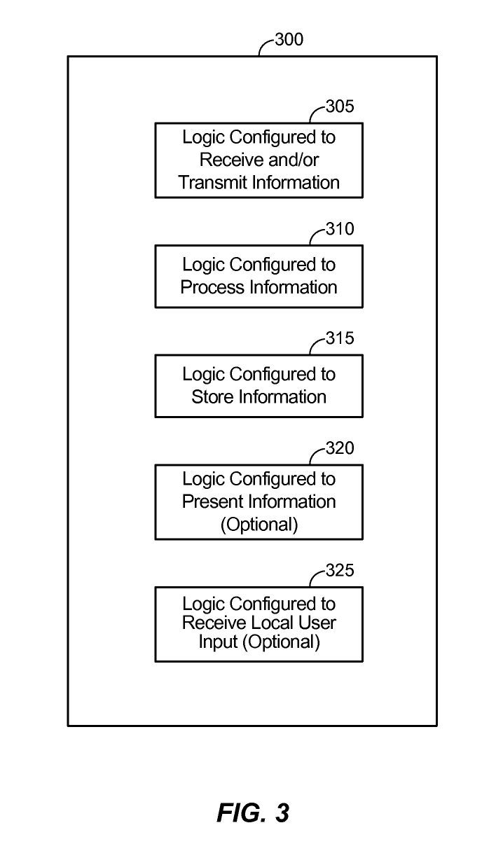

FIG. 3 illustrates a communication device 300 that includes logic configured to perform functionality. The communication device 300 can correspond to any of the above-noted communication devices, including but not limited to Internet of Things (IoT) devices 110-120, Internet of Things (IoT) device 200A, any components coupled to the Internet 175 (e.g., the Internet of Things (IoT) server 170), and so on. Thus, communication device 300 can correspond to any electronic device that is configured to communicate with (or facilitate communication with) one or more other entities over the wireless communications systems 100A-B of FIGS. 1A-B.

Referring to FIG. 3, the communication device 300 includes logic configured to receive and/or transmit information 305. In an example, if the communication device 300 corresponds to a wireless communications device (e.g., Internet of Things (IoT) device 200A and/or passive Internet of Things (IoT) device 200B), the logic configured to receive and/or transmit information 305 can include a wireless communications interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.).

In another example, the logic configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., the application 170), the logic configured to receive and/or transmit information 305 can correspond to an Ethernet card, in an example, that connects the network-based server to other communication entities via an Ethernet protocol.

In a further example, the logic configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, the logic configured to receive and/or transmit information 305 does not correspond to software alone, and the logic configured to receive and/or transmit information 305 relies at least in part upon hardware to achieve its functionality.

Referring to FIG. 3, the communication device 300 further includes logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on.

For example, the processor included in the logic configured to process information 310 can correspond to a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The logic configured to process information 310 can also include software that, when executed, permits the associated hardware of the logic configured to process information 310 to perform its processing function(s). However, the logic configured to process information 310 does not correspond to software alone, and the logic configured to process information 310 relies at least in part upon hardware to achieve its functionality.

Referring to FIG. 3, the communication device 300 further includes logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM, flash memory, ROM, erasable programmable ROM (EPROM), EEPROM, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, the logic configured to store information 315 does not correspond to software alone, and the logic configured to store information 315 relies at least in part upon hardware to achieve its functionality.

Referring to FIG. 3, the communication device 300 further optionally includes logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to the Internet of Things (IoT) device 200A as shown in FIG. 2A and/or the passive Internet of Things (IoT) device 200B as shown in FIG. 2B, the logic configured to present information 320 can include the display 226.

In a further example, the logic configured to present information 320 can be omitted for certain communication devices, such as network communication devices that do not have a local user (e.g., network switches or routers, remote servers, etc.). The logic configured to present information 320 can also include software that, when executed, permits the associated hardware of the logic configured to present information 320 to perform its presentation function(s). However, the logic configured to present information 320 does not correspond to software alone, and the logic configured to present information 320 relies at least in part upon hardware to achieve its functionality.

Referring to FIG. 3, the communication device 300 further optionally includes logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to the Internet of Things (IoT) device 200A as shown in FIG. 2A and/or the passive Internet of Things (IoT) device 200B as shown in FIG. 2B, the logic configured to receive local user input 325 can include the buttons 222, 224A, and 224B, the display 226 (if a touchscreen), etc.

In a further example, the logic configured to receive local user input 325 can be omitted for certain communication devices, such as network communication devices that do not have a local user (e.g., network switches or routers, remote servers, etc.). The logic configured to receive local user input 325 can also include software that, when executed, permits the associated hardware of the logic configured to receive local user input 325 to perform its input reception function(s). However, the logic configured to receive local user input 325 does not correspond to software alone, and the logic configured to receive local user input 325 relies at least in part upon hardware to achieve its functionality.

Referring to FIG. 3, while the configured logics of 305 through 325 are shown as separate or distinct blocks in FIG. 3, it will be appreciated that the hardware and/or software by which the respective configured logic performs its functionality can overlap in part. For example, any software used to facilitate the functionality of the configured logics of 305 through 325 can be stored in the non-transitory memory associated with the logic configured to store information 315, such that the configured logics of 305 through 325 each performs their functionality (i.e., in this case, software execution) based in part upon the operation of software stored by the logic configured to store information 315.

Likewise, hardware that is directly associated with one of the configured logics can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an aspect that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the aspects described below in more detail.

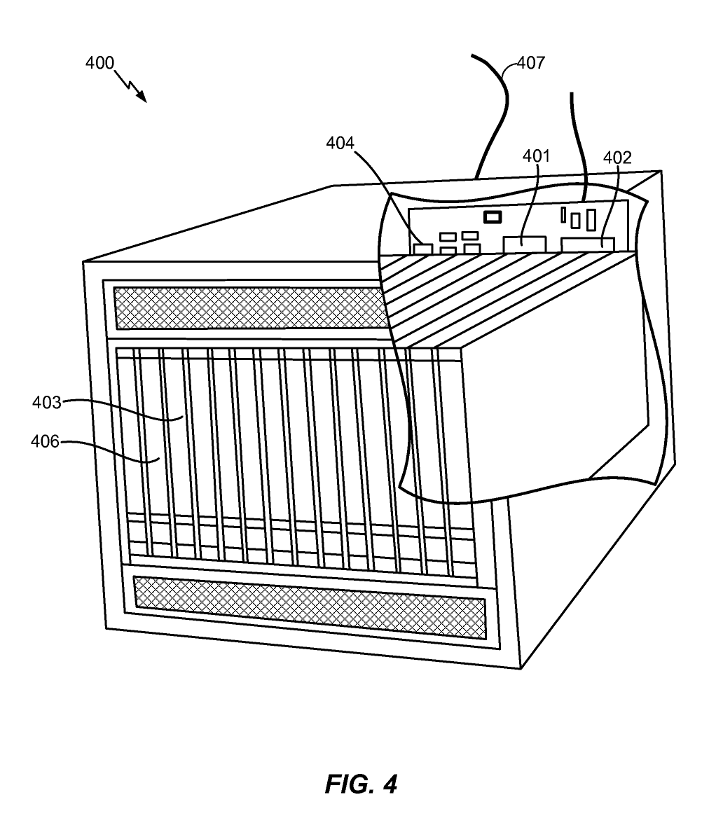

The various implementations may be implemented on any of a variety of commercially available server devices, such as server 400 illustrated in FIG. 4. In an example, the server 400 may correspond to one example configuration of the Internet of Things (IoT) server 170 described above. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet.

In context with FIG. 3, it will be appreciated that the server 400 of FIG. 4 illustrates one example implementation of the communication device 300, whereby the logic configured to transmit and/or receive information 305 corresponds to the network access points 404 used by the server 400 to communicate with the network 407, the logic configured to process information 310 corresponds to the processor 401, and the logic configuration to store information 315 corresponds to any combination of the volatile memory 402, the disk drive 403 and/or the disc drive 406. The optional logic configured to present information 320 and the optional logic configured to receive local user input 325 are not shown explicitly in FIG. 4 and may or may not be included therein. Thus, FIG. 4 helps to demonstrate that the communication device 300 may be implemented as a server, in addition to an Internet of Things (IoT) device implementation as in FIG. 2A.

In an Internet of Things (IoT) network or environment, enhanced functionality can be acquired in certain use cases based on knowledge regarding whether two or more Internet of Things (IoT) devices are in close physical proximity to each other. As used herein, close physical proximity can correspond to Internet of Things (IoT) devices being in the same room as each other, or being a few feet away from each other in the same room, or even being a few feet away from each other in different rooms with an intervening wall between the respective Internet of Things (IoT) devices.

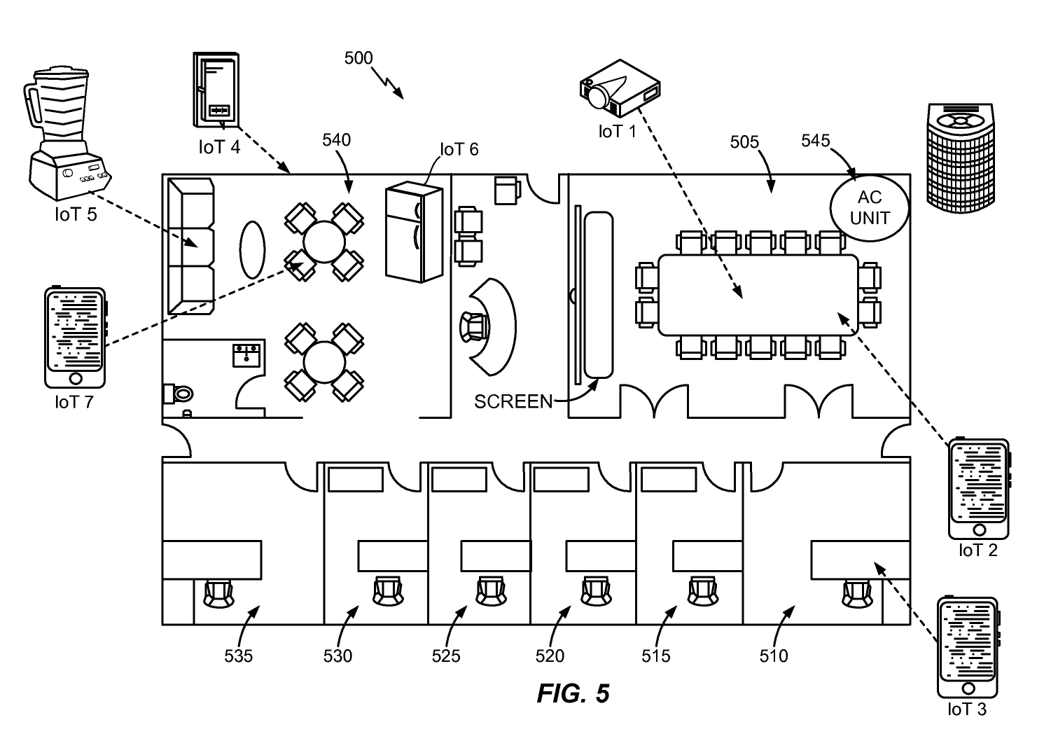

FIG. 5 illustrates an example of an Internet of Things (IoT) environment 500 in accordance with an implementation of the technology described herein. In FIG. 5, the Internet of Things (IoT) environment 500 is an office space with a conference room 505, a plurality of offices 510 through 535 and a kitchen 540. Within the office space, Internet of Things (IoT) device 1 (e.g., a video projector) and Internet of Things (IoT) device 2 (e.g., a handset device such as a cell phone or tablet computer) are positioned the conference room 505, and Internet of Things (IoT) device 3 (e.g., a handset device such as a cell phone or tablet computer) is positioned in office 510. Also, Internet of Things (IoT) device 4 (e.g., a thermostat), Internet of Things (IoT) device 5 (e.g., a blender), Internet of Things (IoT) device 6 (e.g., a refrigerator) and Internet of Things (IoT) device 7 (e.g., a handset device such as a cell phone or tablet computer being operated by an employee on his/her lunch break) are positioned in the kitchen 540. An air conditioning unit 545 also is positioned in the conference room 505. As will be appreciated, while the Internet of Things (IoT) environment 500 of FIG. 5 is directed to an office, many other configurations of Internet of Things (IoT) environments are also possible (e.g., residential homes, retail stores, vehicles, stadiums, etc.).

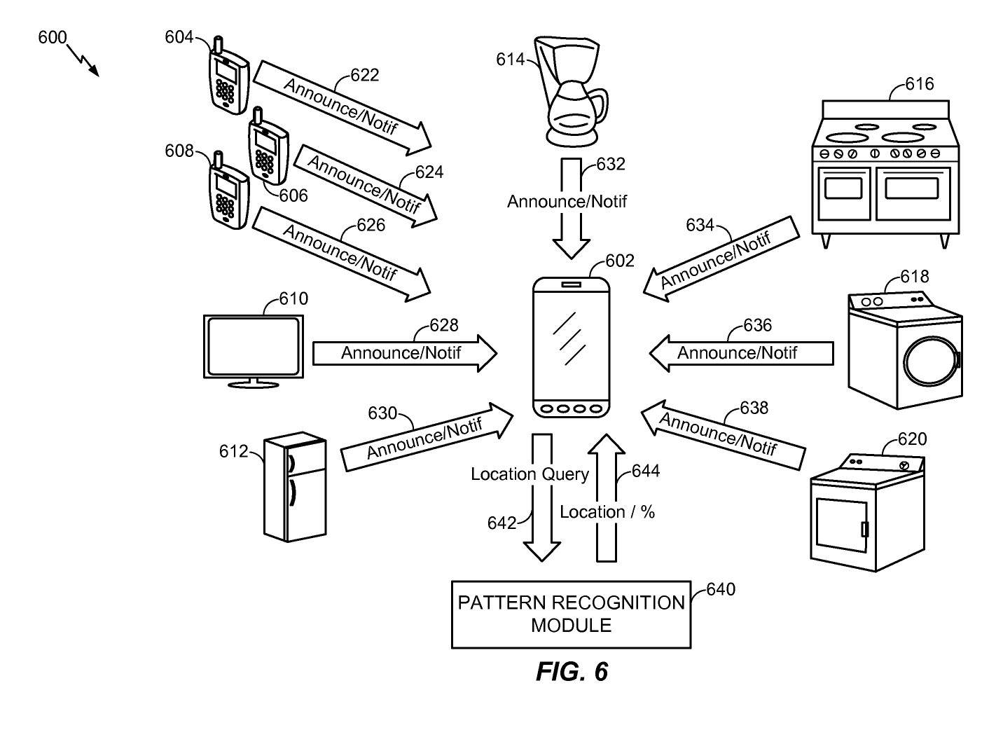

FIG. 6 illustrates an example of an Internet of Things (IoT) home environment 600 (i.e., where the Wi-Fi network is located) in accordance with one or more implementations of the technology described herein. In the illustrated implementation, the home environment 600 includes a computing device 602 along with three handsets 604, 606, and 608. The environment 600 also includes a television 610, a refrigerator 612, a coffee maker 614, an oven 616, a washing machine 618, and a dryer 620. Although illustrated as a smart phone, the computing device 602 may be a laptop computer, a tablet computer, a PDA, or the like. The computing device 602 also may be an Internet of Things (IoT) device and/or contain functionality to manage an Internet of Things (IoT) network/group.

In one implementation, the computing device 602 acquires information from the three handsets 604, 606, and 608. The computing device 602 also acquires information from the television 610, the refrigerator 612, the coffee maker 614, the oven 616, the washing machine 618, and the dryer 620. The information can be in the form of announcements broadcast from the Internet of Things (IoT) devices in the environment 600. As used herein, an “announcement” is a broadcast by a device that declares and describes its existence and capabilities in the environment 600. The information also can be in the form of notifications broadcast from the Internet of Things (IoT) devices in the environment 600. As used herein, a “notification” is a broadcast in which specific events are carried. The computing device 602 then maps the notifications to the Internet of Things (IoT) device. The announcements can include data in which the Internet of Things (IoT) devices inform the computing device 602 of what type of Internet of Things (IoT) device it is. In one or more implementations, the announcement can include either the “model” of the device or the services the device offers. Services can be things like “printing,” “baking,” and so forth.

For example, the handset 604 may broadcast an announcement (622) in the form of “About announcement—Model=handset,” the handset 606 may broadcast an announcement (624) in the form of “About announcement—Model=handset,” and the handset 608 may broadcast an announcement (626) in the form of “About announcement—Model=handset.” Similarly, the television 610 may broadcast an announcement (628) in the form of “About announcement—Model=television,” the refrigerator 612 may broadcast an announcement (630) in the form of “About announcement—Model=refrigerator,” the coffee maker 614 may broadcast an announcement (632) in the form of “About announcement—Model=coffee maker,” the oven 616 may broadcast an announcement (634) in the form of “About announcement—Model=oven,” the washing machine 618 may broadcast an announcement (636) in the form of “About announcement—Model=washing machine,” and the dryer 620 may broadcast an announcement (638) in the form of “About announcement—Model=dryer.”

The handset 604 can also broadcast notifications from the Internet of Things (IoT) devices to the computing device 602. As used herein, a “notification” is a broadcast in which specific events are carried. The computing device 602 then maps the notifications to the Internet of Things (IoT) device. These notifications may be semantically mapped from human readable messages to machine-to-machine mappings. For example, if the washing machine 618 broadcasts a notification (636) in the form of “the delicate cycle is complete,” the computing device 602 mapping would determine that the Internet of Things (IoT) device 618 is a washing machine.

Similarly, if the dryer 620 broadcasts a notification (638) in the form of “the permanent press cycle is done,” the computing device 602 mapping would determine that the Internet of Things (IoT) device 620 is a dryer. After reading the description herein, a person of ordinary skill will be able to apply these notifications to the other Internet of Things (IoT) devices in the environment 600.

In one or more implementations, Internet of Things (IoT) devices may broadcast their presence in a manner that is not meant to be understood by the computing device 602. Instead, the broadcasts are meant to be displayed to a user of the computing device 602, understood by the user, and meaningful to the user in the form of human-readable communications such as text (e.g., Short Message Service (SMS)), images, video, audio, haptics, and the like. That is, the computing device 602 does not understand what is being broadcast by the Internet of Things (IoT) device because the broadcasts do not have message codes or the kind of identification that messages typically utilize in machine-to-machine communication.

The announcements also can include semantic mappings from human readable messages to machine-to-machine codes and/or tags, or the mapping can be performed by an external component. The semantic mapping is used any time the “data” or “message” transmitted is a human readable piece of data as opposed to some pre-agreed upon data mapping between the machines.

To illustrate, if the data or message transmitted is “Red,” a semantic mapping would be used for a computer to understand what “Red” is. However, if the RGB value of 0xFF0000 is transmitted, which is the value for “Red,” semantic mapping may not be performed since the RGB value of 0xFF0000 is a value the computer understands. Similarly, if there is a predefined dictionary that maps, for example, the number 123321 to mean “printer,” no semantic mapping is used. However, if the word “printer” is transmitted, the recipient would employ a mapping logic/algorithm that maps the English word “printer” to a predefined dictionary word. After reading the description herein, a person of ordinary skill will be able to apply semantic mappings to the other Internet of Things (IoT) devices in the environment 600.

In one or more implementations, a semantic mapper (not shown) maps a user interface for Internet of Things (IoT) devices to a programmatic interface, such as an API. This may be accomplished by having the semantic mapper assign semantic tags to remotely exposed generic properties of the Internet of Things (IoT) devices.

Table 1 illustrates an example of mapping performed by a semantic mapper to map a user interface for Internet of Things (IoT) devices to a programmatic interface.

TABLE 1

| Protocol | Text | Code | Device |
|---|---|---|---|
| “notification” | “Your dishwasher has finished | 5451 | Dishwasher |
| | its cycle” | | |
| “notification” | “Missed calls” | 7232 | Telephone |
| user interface | “Temperature” | 7612 | Furnace |
| SMS | “The delicate cycle is complete” | 1234 | Washer |

Because the environment 600 is a home environment the environment 600 will have a certain pattern for the different types of devices, their quantities, transience, etc. That is, the handsets 604, 606, and 608 typically belong to the residents of the home and do not change unless a new handset is brought into the home environment 600. Moreover, the television 610, refrigerator 612, coffee maker 614, oven 616, washing machine 618, and dryer 620 typically do not change and they are not transient.

Alternatively, the handset 606 may have a pattern of being located in the environment 600 during the hours of 7:00 P.M. through 7:30 A.M., on weekdays, and being away from the environment 600 during the remaining hours. This pattern of existence for the handset 606 may also be recognized.

Similarly, the handset 608 may have a pattern of being intermittently located in the environment 600 during the hours of 7:30 A.M. through 5:00 P.M., and being always in the environment 600 during the remaining hours. This pattern of existence for the handset 608 may also be recognized.

After gathering the announcements and/or notifications from the Internet of Things (IoT) devices, the computing device 602 queries a pattern recognition module 640 for the type of location for the Internet of Things (IoT) environment 600 using location query 642. In on ore more implementations, the pattern recognition module 640 determines what types of Internet of Things (IoT) devices exist in the Internet of Things (IoT) environment 600 based on the announcements. The pattern recognition module 640 also recognizes patterns for the different types of devices, their quantities, their transience, etc. The pattern recognition module 640 then makes heuristic and probabilistic determinations using machine learning and/or pattern recognition algorithms to categorize/classify the Internet of Things (IoT) environment 600 with a confidence level. The pattern recognition module 640 returns the category and confidence level to the computing device 602 using location/% 644.

In one or more implementations, the pattern recognition module 640 may include a server, a software component, or other suitable technology that is capable of making heuristic and probabilistic determinations using machine learning and/or pattern recognition algorithms. The pattern recognition module 640 is described in more detail below.

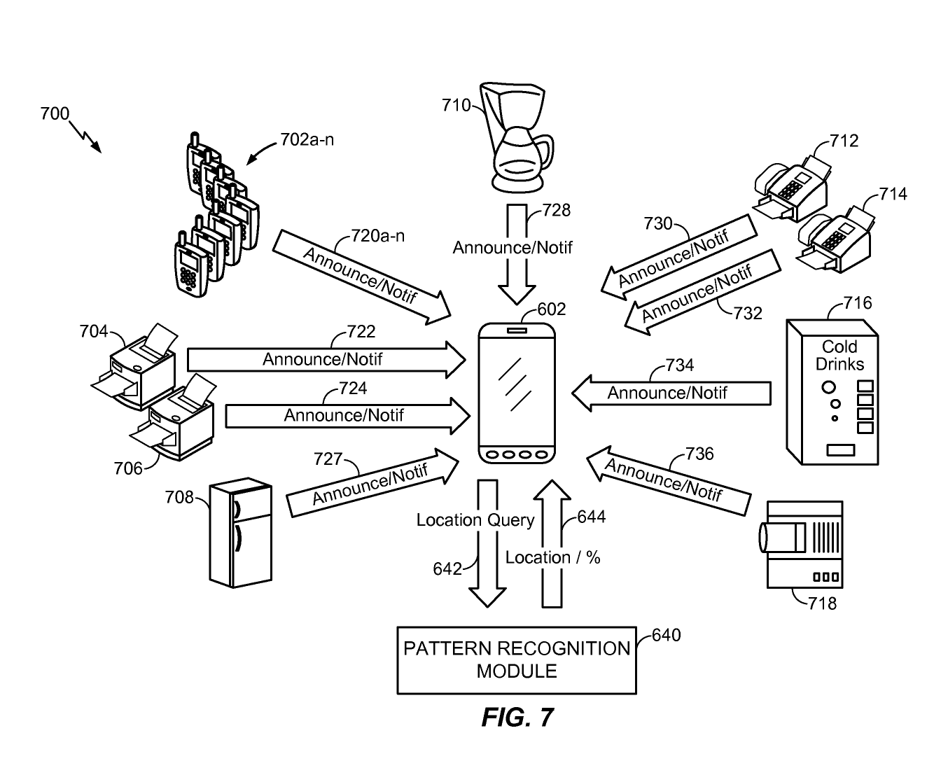

FIG. 7 illustrates an example of an Internet of Things (IoT) office environment 700 in accordance with one or more implementations of the technology described herein. In the illustrated implementation, the office environment 700 includes the computing device 602 along with several handsets 702a-n. The environment 700 also includes two printers 704 and 706, a refrigerator 708, a coffee maker 710, two fax machines 712 and 714, a vending machine 716, and a projector 718.

In one implementation, the computing device 602 acquires information from the several handsets 702a-n, two printers 704 and 706, refrigerator 708, coffee maker 710, two fax machines 712 and 714, vending machine 716, and projector 718. The information can be in the form of announcements broadcast from the Internet of Things (IoT) devices in the environment 700 similar to the announcements in the environment 600. For example, the announcements can include data in which the Internet of Things (IoT) devices inform the computing device 602 of what type of Internet of Things (IoT) device it is.

For example, each handset 702a-n may broadcast an announcement (720a-n) in the form of “About announcement—Model=handset,” the printer 704 may broadcast an announcement (722) in the form of “About announcement—Model=printer,” and the printer 706 may broadcast an announcement (724) in the form of “About announcement—Model=printer.” Similarly, the refrigerator 708 may broadcast an announcement (727) in the form of “About announcement—Model=refrigerator,” the coffee maker 710 may broadcast an announcement (728) in the form of “About announcement—Model=coffee maker,” the fax machine 712 may broadcast an announcement (730) in the form of “About announcement—Model=fax machine,” the fax machine 714 may broadcast an announcement (732) in the form of “About announcement—Model=fax machine,” the vending machine 716 may broadcast an announcement (734) in the form of “About announcement—Model=vending machine,” and the projector 718 may broadcast an announcement (736) in the form of “About announcement—Model=projector.”

As is the case in the home environment 600 there can be notifications from the Internet of Things (IoT) devices in the office environment 700 from the Internet of Things (IoT) devices to the computing device 602. The computing device 602 then maps the notifications to the Internet of Things (IoT) device. For example, if the vending machine 716 broadcasts a notification (734) in the form of “potato chips are empty,” the computing device 602 mapping would determine that the Internet of Things (IoT) device 716 is a vending machine.

Similarly, if the printer 704 broadcasts a notification (722) in the form of “document finished printing,” the computing device 602 mapping would determine that the Internet of Things (IoT) device 704 is a printer. If the refrigerator 708 broadcasts a notification (727) in the form of “you may set the temperature for the freezer,” the computing device 602 mapping would determine that the Internet of Things (IoT) device 708 is a refrigerator. If the printer 706 broadcasts a notification (724) in the form of “please load paper,” the computing device 602 mapping would determine that the Internet of Things (IoT) device 706 is a printer. After reading the description herein, a person of ordinary skill will be able to apply these notifications to the other Internet of Things (IoT) devices in the environment 700.

The announcements in the environment 700 also can include semantic mappings from human readable messages to machine-to-machine mappings as described above with reference to FIG. 6. After reading the description herein, a person of ordinary skill will be able to apply semantic mappings to the other Internet of Things (IoT) devices in the environment 700.

Because the environment 700 is an office environment the environment 700 will have a certain pattern for the different types of devices, their quantities, transience, etc. That is, some of the handsets 702a-n may be company issued; others may be personally owned. Moreover, the printers 704 and 706, refrigerator 708, fax machines 712 and 714, and vending machine 716 typically do not change and they are not transient. The projector 718, however, can be transient.

After gathering the announcements from the Internet of Things (IoT) devices, the computing device 602 queries the pattern recognition module 640 for the type of location for the Internet of Things (IoT) environment 700 using location query 642. In on ore more implementations, the pattern recognition module 640 determines what types of Internet of Things (IoT) devices exist in the Internet of Things (IoT) environment 700 based on the announcements. The pattern recognition module 640 also recognizes patterns for the different types of devices, their quantities, their transience, etc. The pattern recognition module 640 then makes heuristic and probabilistic determinations using machine learning and/or pattern recognition algorithms to categorize/classify the Internet of Things (IoT) environment 700 with a confidence level. The pattern recognition module 640 returns the category and confidence level to the computing device 602 using location/% 644.

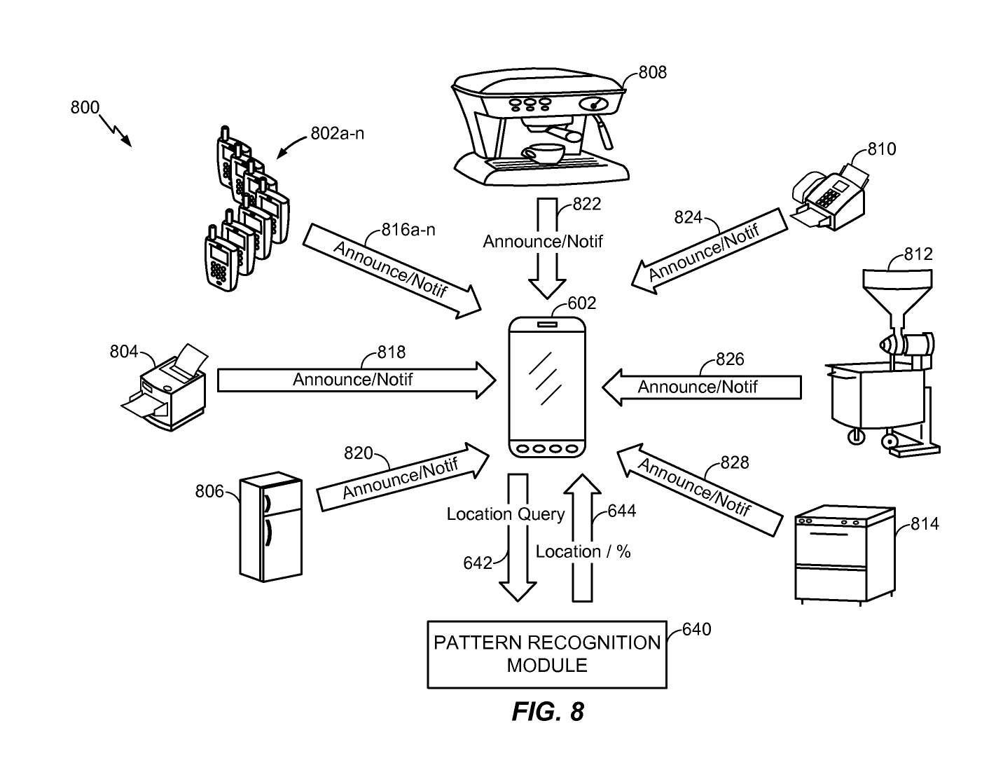

FIG. 8 illustrates an example of an Internet of Things (IoT) retail environment 800 in accordance with one or more implementations of the technology described herein, in which, for the purposes of explanation, is assumed to be a coffee shop. In the illustrated implementation, the retail environment 800 includes the computing device 602 along with several handsets 802a-n. The environment 800 also includes a printer 804, a refrigerator 806, a commercial espresso machine 808, a fax machine 810, a commercial coffee bean grinding machine 812, and a commercial dishwasher 814.

In one implementation, the computing device 602 acquires information from the several handsets 802a-n, printer 804, refrigerator 806, espresso machine 808, fax machine 810, grinding machine 812, and commercial dishwasher 814. The information can be in the form of announcements broadcast from the Internet of Things (IoT) devices in the environment 800 similar to the announcements in the environment 600 and the environment 700. For example, the announcements can include data in which the Internet of Things (IoT) devices inform the computing device 602 of what type of Internet of Things (IoT) device it is.

For example, each handset 802a-n may broadcast an announcement (816a-n) in the form of “About announcement—Model=handset 802a-n,” the printer 804 may broadcast an announcement (818) in the form of “About announcement—Model=printer,” the refrigerator 808 may broadcast an announcement (820) in the form of “About announcement—Model=refrigerator,” the espresso machine 808 may broadcast an announcement (822) in the form of “About announcement—Model=espresso machine,” the fax machine 810 may broadcast an announcement (824) in the form of “About announcement—Model=fax machine,” the coffee grinder 812 may broadcast an announcement (826) in the form of “About announcement—Model=coffee grinder,” and the dishwasher 814 may broadcast an announcement (828) in the form of “About announcement—Model=dishwasher.”

As is the case in the home environment 600 and/or office environment 700, there also can be notifications from the Internet of Things (IoT) devices in the office environment 800 to the computing device 602. The computing device 602 then maps the notifications to the Internet of Things (IoT) device. For example, if the refrigerator 806 broadcasts notifications (820) in the form of “ice receptacle is empty,” the computing device 602 mapping would determine that the Internet of Things (IoT) device 806 is a refrigerator. Similarly, if the dishwasher 814 broadcasts a notification (828) in the form of “cups finished drying,” the computing device 602 mapping would determine that the Internet of Things (IoT) device 814 is a dishwasher. After reading the description herein, a person of ordinary skill will be able to apply these notifications to the other Internet of Things (IoT) devices in the environment 800.

The announcements in the environment 800 also can include semantic mappings from human readable messages to machine-to-machine mappings as described above with reference to FIG. 6. and/or FIG. 7. After reading the description herein, a person of ordinary skill will be able to apply semantic mappings to the other Internet of Things (IoT) devices in the environment 800.

Because the environment 800 is a retail environment, such as a coffee shop, the environment 800 will have a certain pattern for the different types of devices, their quantities, transience, etc. For example, most of the handsets 802a-n are transient. Moreover, there will be a lot of phones that come in and out of the environment 800 every day I go there the same 40 phones are there. Over the course of a half-hour there could be over two hundred phones in the coffee shop, but they are will be all changing. Additionally, the printer 804, refrigerator 806, fax machine 810, grinding machine 812, and commercial dishwasher 814 typically do not change and they are not transient.

After gathering the announcements from the Internet of Things (IoT) devices, the computing device 602 queries the pattern recognition module 640 for the type of location for the Internet of Things (IoT) environment 800 using location query 642. In on ore more implementations, the pattern recognition module 640 determines what types of Internet of Things (IoT) devices exist in the Internet of Things (IoT) environment 800 based on the announcements. The pattern recognition module 640 also recognizes patterns for the different types of devices, their quantities, their transience, etc. The pattern recognition module 640 then makes heuristic and probabilistic determinations using machine learning and/or pattern recognition algorithms to categorize/classify the Internet of Things (IoT) environment 800 with a confidence level. The pattern recognition module 640 returns the category and confidence level to the computing device 602 using location/% 644.

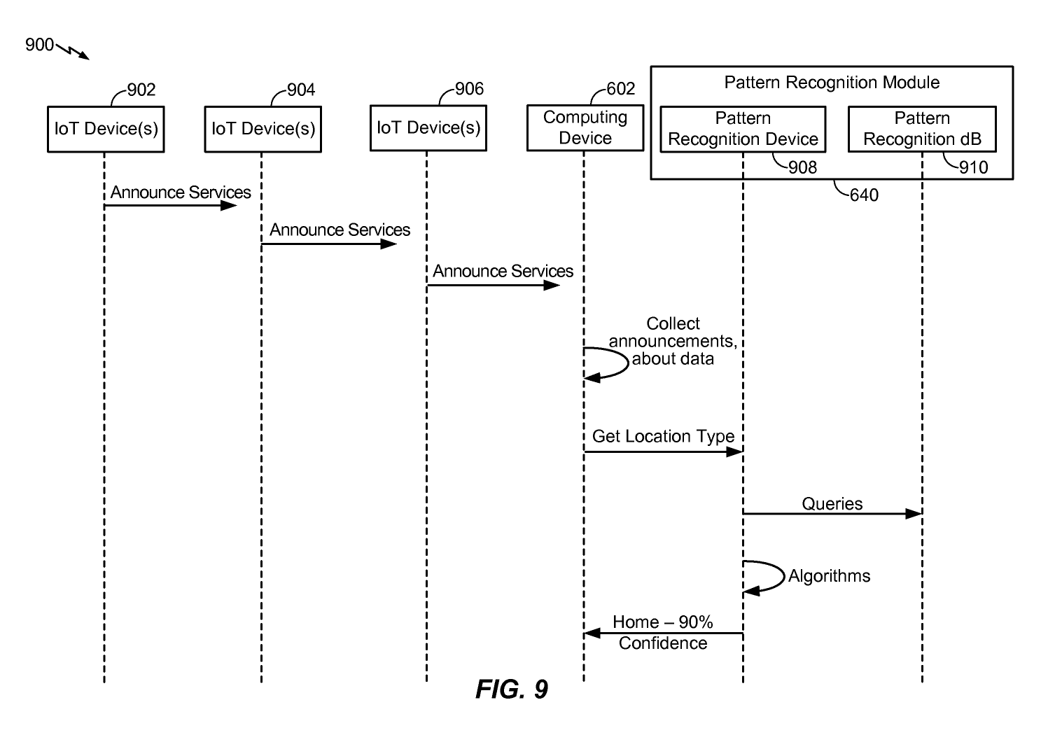

FIG. 9 illustrates an example message sequence 900 in which a type of Internet of Things (IoT) environment is recognized in accordance with one or more implementations of the technology described herein. The illustrated message sequence 900 depicts several Internet of Things (IoT) devices 802, 804, and 806, the computing device 602, and the pattern recognition module 640. The illustrated pattern recognition module 640 includes a pattern recognition engine 808 and a pattern recognition database 810. The pattern recognition module 604 determines one or more types for the Internet of Things (IoT) devices 802, 804, and 806 are based on the announcements. The pattern recognition module 640 also recognizes patterns of the different types of Internet of Things (IoT) devices that Internet of Things (IoT) devices 802, 804, and 806 are. The pattern recognition module then deduces the type of environment that the Internet of Things (IoT) devices 802, 804, and 806 are located based on the announcements and machine learning.

In one or more example implementations, the Internet of Things (IoT) devices 802, 804, and 806 announce themselves (“announce services”). The announcements can be in the form of data in which the Internet of Things (IoT) devices inform the computing device 602 of what type of Internet of Things (IoT) device it is. The announcements also can be in the form of notifications, service interfaces, and/or semantic mappings from human readable messages to machine-to-machine mappings.

In the illustrated example, the computing device 602 collects the announcements from the Internet of Things (IoT) devices 902, 904, and 906 (“collect announcements, about data”). The computing device 602 then requests a location type from the pattern recognition device pattern recognition device 908 (“Get Location Type”). The pattern recognition device 908 queries the pattern recognition database 904 for location types (“Queries”). The pattern recognition device 908 acquires the location types and executes machine learning algorithms using the announcements acquired from the Internet of Things (IoT) devices and the location types acquired from the pattern recognition database 910. The pattern recognition device 908 then makes a decision using machine learning (“Algorithms”) of the type of Internet of Things (IoT) environment and provides a level of confidence for the decision (“Home—90% Confidence”). That is, the pattern recognition device 908 has determined, based on the announcement from the Internet of Things (IoT) devices 902, 904, and 906 and the machine learning algorithms that the environment where the Internet of Things (IoT) devices 902, 904, and 906 are located is a home environment and the determination is made with 90% confidence.

In one or more implementations, the pattern recognition device 908 may be a server, a software component, or other technology that is capable of implementing one or more pattern recognition algorithms, based on machine learning and history, for example. For instance, the pattern recognition device 908 may implement one or more algorithms to provide a reasonable answer for all possible Internet of Things (IoT) device inputs and to perform “most likely” matching of the Internet of Things (IoT) device inputs, taking into account their statistical variation. The “most likely” matching can take the form of a percent of confidence of the match. In one or more implementations, the pattern recognition device 908 may implement classification, regression, or the like.

In one or more implementations, the pattern recognition database 910, which is optional, may be any database that is capable of storing information regarding categorizations/classifications of Internet of Things (IoT) locations. The computing device 602 may receive the information regarding categorizations/classifications from the database 910. Information can include history, training, and/or learning data as implemented by machine learning technologies. Locations may include retail locations, cafes, coffee shops, offices, schools, homes, train stations, stadiums, libraries, etc.

As an example, suppose that there are five Internet of Things (IoT) locations that have been categorized as follows: 1=café, 2=home, 3=office, 4=home, 5=café. The pattern recognition module 640 may look at the characteristics of each of the Internet of Things (IoT) devices in the five locations based on their announcements. The pattern recognition module 640 may raise the metrics of the likelihood of those Internet of Things (IoT) devices being present in those kinds of locations. Thus, if there are one hundred locations in the pattern recognition database 910 that are categorized as a coffee shop, and each of the one hundred locations have Internet of Things (IoT)-enabled commercial espresso machines, then the next time the computing device 602 enters a location that the pattern recognition module 640 has not yet categorized, and the computing device 602 detects a commercial espresso machine, the metric of the likelihood that the location is a coffee shop will be raised. Pattern recognition techniques suitable for implementing the pattern recognition module are well known.

Various aspects have been disclosed in the above description and related drawings to show specific examples relating to example implementations of the mechanism for determining a type of indoor location using pattern matching of proximal peer-to-peer of Internet of Things (IoT)) devices. Alternative implementations will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and implementations disclosed herein.

The word “example” is used herein to mean “serving as an example, instance, or illustration.” Any implementation described herein as “example” is not necessarily to be construed as preferred or advantageous over other implementations. Likewise, the term “implementations” does not require that all implementations include the discussed feature, advantage, or mode of operation.

The terminology used herein describes particular implementations only and should not be construed to limit any implementations disclosed herein. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system Skilled artisans may implement the described functionality in varying ways for each particular application, but such implementation decisions should not be interpreted to depart from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in an Internet of Things (IoT) device. In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically and/or optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps, and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of determining a location type for a computing device, comprising:
acquiring a presence of a set of Internet of Things (IoT) devices;
determining classifications of device types of the one or more IoT devices; and
determining a location type for the computing device based at least in part on the classifications of device types.

2. The method of claim 1, wherein determining the classifications of the device types comprises determining the classifications of the device types at the computing device.

3. The method of claim 1, wherein determining the classifications of the device types comprises receiving classification information at the computing device.

4. The method of claim 1, wherein determining the location type is based on pattern recognition.

5. The method of claim 4, wherein determining the location type is further based on a confidence level.

6. The method of claim 1, wherein determining the location type is based on at least one of hard-coded logic or machine learning.

7. The method of claim 1, wherein if determining the classifications of the device types includes determining the device types to be at least two devices selected from a group comprising an oven, a washing machine, a dryer, and a refrigerator, then further comprising determining the location type to be a home.

8. The method of claim 1, wherein if determining the classifications of the device types includes determining a device type to be a vending machine, then further comprising determining that the location type is an office.

9. The method of claim 1, wherein if determining the classifications of the device types includes determining the device types to be at least two devices selected from a group comprising a commercial espresso machine, a commercial coffee bean grinding machine, a commercial dishwasher, and a plurality of transient user devices, then further comprising determining the location type to be a retail environment.

10. An apparatus for determining a location type for a computing device, comprising:
logic that is configured to acquire a presence of a set of Internet of Things (IoT) devices;
logic that is configured to determine classifications of device types of the one or more IoT devices; and
logic that is configured to determine a location type for the computing device based at least in part on the classifications of device types.

11. The apparatus of claim 10, wherein the logic that is configured to determine classifications of device types comprises logic located at the computing device.

12. The apparatus of claim 10, wherein the logic that is configured to determine classifications of device types comprises logic that is configured to receive external classification information at the computing device.

13. The apparatus of claim 10, wherein the logic that is configured to determine classifications of device types comprises at least one of pattern recognition logic, machine learning logic, or hard-coded logic.

14. The apparatus of claim 10, wherein:
the logic that is configured to determine classifications of device types is further configured to determine that the device types are at least two devices selected from a group comprising an oven, a washing machine, a dryer, and a refrigerator; and
the logic that is configured to determine a location type is further configured to determine that the location type is a home based on the determination that the device types are at least two devices selected from the group comprising an oven, a washing machine, a dryer, and a refrigerator.

15. The apparatus of claim 10, wherein:
the logic that is configured to determine classifications of device types is further configured to determine that one of the device types is a vending machine; and
the logic that is configured to determine a location type is further configured to determine that the location type is an office based on the determination that the device type is a vending machine.

16. The apparatus of claim 10, wherein:
the logic that is configured to determine classifications of device types is further configured to determine that the device types are at least two devices selected from a group comprising a commercial espresso machine, a commercial coffee bean grinding machine, a commercial dishwasher, and a plurality of transient user devices; and
the logic that is configured to determine a location type is further configured to determine that the location type is a retail environment based on the determination that the device types are at least two devices selected from the group comprising a commercial espresso machine, a commercial coffee bean grinding machine, a commercial dishwasher, and a plurality of transient user devices.

17. An apparatus for determining a location type for a computing device, comprising:
means for acquiring a presence of a set of Internet of Things (IoT) devices;
means for determining classifications of device types of the one or more IoT devices; and
means for determining a location type for the computing device based at least in part on the classifications of device types.

18. The apparatus of claim 17, wherein the means for determining the classifications of the device types comprises means for determining the classifications of the device types at the computing device.

19. The apparatus of claim 17, wherein the means for determining the classifications of the device types comprises means for receiving external classification information at the computing device.

20. The apparatus of claim 17, wherein the means for determining the location type is a pattern recognition module.

21. The apparatus of claim 17, wherein the means for determining the location type is a machine learning module.

22. The apparatus of claim 17, wherein the means for determining the location type is hard-coded logic.

23. The apparatus of claim 17, wherein if the means for determining the classifications of device types includes means for determining the device types to be at least two devices selected from a group comprising an oven, a washing machine, a dryer, and a refrigerator, then the means for determining a location type further comprises means for determining the location type to be a home.

24. The apparatus of claim 17, wherein if the means for determining the classifications of device types includes means for determining a device type to be a vending machine, then the means for determining a location type further comprises means for determining the location type to be an office.

25. The apparatus of claim 17, wherein if the means for determining the classifications of device types includes means for determining the device types to be at least two devices selected from a group comprising a commercial espresso machine, a commercial coffee bean grinding machine, a commercial dishwasher, and a plurality of transient user devices, then the means for determining a location type further comprises means for determining the location type to be a retail environment.

26. A computer-readable storage medium including data that, when accessed by a machine, cause the machine to perform operations for determining a location type for a computing device, the operations comprising:
acquiring a presence of a set of Internet of Things (IoT) devices;
determining classifications of device types of the one or more IoT devices; and
determining a location type for the computing device based at least in part on the classifications of device types.

27. The computer-readable storage medium of claim 26, further comprising data that, when accessed by the machine, cause the machine to perform operations of determining the location type based on pattern recognition.

28. The computer-readable storage medium of claim 26, further comprising data that, when accessed by the machine, cause the machine to perform operations of determining the location type based on at least one of hard-coded logic or machine learning.

29. The computer-readable storage medium of claim 26, further comprising data that, when accessed by the machine, cause the machine to perform operations of determining a likelihood that one or more of the device types is located in the location type.

30. The computer-readable storage medium of claim 26, further comprising data that, when accessed by the machine, cause the machine to perform operations of if determining the classifications of the device types includes determining the device types to be at least two devices selected from a group comprising an oven, a washing machine, a dryer, and a refrigerator, then further comprising determining the location type to be a home.
